(19) United States
(12) Patent Application Publication
(10) Pub. No.: US 2012/0042023 A1
(43) Pub. Date: Feb. 16, 2012

(54) MAILING LIST DEVICE AND PROGRAM

(76) Inventor: TAKASHI AKIU, Tokyo (JP)

(21) Appl. No.: 13/198,331

(22) Filed: Aug. 4, 2011

(30) Foreign Application Priority Data
Aug. 11, 2010 (JP) 2010-180142

(51) Int. Cl. G06F 15/16

(52) U.S. Cl. 709/206

(57) ABSTRACT

The present invention provides a destination address acquisition section 21 which receives an original e-mail addressed to a mailing list transmitted from a client terminal 1, and acquires addresses of members included in the mailing list; a specific address judgment section 22 which, based on information included in a header of the original e-mail, judges whether a specific action is required for each of members; and an e-mail distribution section 23 which, based on the judgment result of the specific address judgment section 22, distributes e-mails, for which control is executed to perform or not to perform the action, to each of the members. The header of the original e-mail includes a condition for classifying members and flag information for designating whether the specific action is needed for members to which the condition applies, and the specific address judgment section 22 judges whether the specific action is necessary based on the flag information.

### CROSS-REFERENCES

This application is based upon and claims the benefit of priority from Japanese patent application No. 2010-180142, filed on Aug. 11, 2010, the disclosure of which is incorporated herein in its entirety by reference.

### BACKGROUND

This invention relates to a mailing list device and program.

In a mailing list device of the prior art, when e-mail is transmitted to a mailing list, generally e-mail with the same contents is distributed to all the destinations registered on the mailing list. However, when attaching a large-size attached file to e-mail, there are cases in which it is desired to attach the file for specific members, but send only the e-mail contents, without an attachment, to the other members. In such cases, it has been necessary to create and transmit separate e-mails to the addresses of members for whom file attachment is not necessary.

Japanese Patent Laid-open No. 2004-127065 discloses a method wherein, when transmitting e-mail using a mailing list service, the transmitter designates addresses for distribution of attached files or addresses to which attached files are not distributed, and the mailing list server transmits e-mail with attached files to addresses for which there has been a distribution instruction, and transmits e-mail without attached files to addresses without such an instruction, according to the aforementioned designation.

### SUMMARY

An exemplary object of the invention is to provide a mailing list device which, by a simple method, designates specific destinations and destinations other than the specific destinations among the destinations registered on a mailing list, and which can perform a specific action only for e-mail transmitted to specific destinations.

A mailing list device according to an exemplary aspect of the invention includes a destination address acquisition section which receives an original e-mail addressed to a mailing list transmitted from a user terminal, and acquires addresses of members included in the mailing list; a specific address judgment section which, based on information included in a header of the original e-mail, judges whether a specific action is required for each of members included in the mailing list; and an e-mail distribution section which, based on the judgment result of the specific address judgment section, distributes e-mails, for which control is executed to perform or not to perform the action, to each of the members, wherein the header of the original e-mail includes a condition for classifying members and flag information designating whether the specific action is needed for members to which the condition applies, and the specific address judgment section judges whether the specific action is necessary based on the flag information.

### DESCRIPTION OF THE DRAWINGS

FIG. 1 is a block diagram showing the configuration of a server (mailing list device) in an exemplary embodiment of the invention;

FIG. 2 shows an example of information stored in a mailing list destination database in an exemplary embodiment of the invention;

FIG. 3 shows an example of a header section of e-mail transmitted from a client terminal in an exemplary embodiment of the invention; and

FIG. 4 is a flowchart of operation of a server which has received e-mail from a client terminal in an exemplary embodiment of the invention.

### EXEMPLARY EMBODIMENT

Next, an exemplary embodiment of the invention is explained in detail, referring to the drawings.

### Exemplary Embodiment

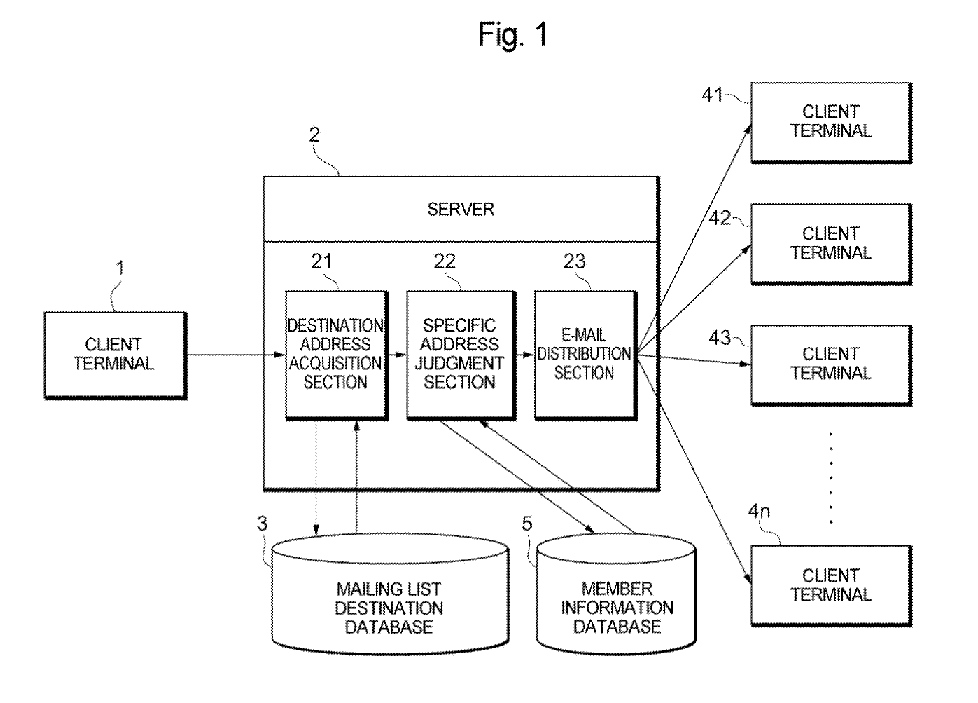

FIG. 1 is a block diagram showing the configuration of a server (mailing list device) 2 of an exemplary embodiment of the invention. As shown in FIG. 1, the server 2 comprises a destination address acquisition section 21, specific address judgment section 22, e-mail distribution section 23, mailing list destination database 3, and member information database 5.

The server 2 is connected to client terminals 1, 41-4n via communication lines.

The member information database 5 need not be stored on the server 2, and an external member system or other database may be connected to the server 2.

The destination address acquisition section 21, specific address judgment section 22, and e-mail distribution section 23 represent modules of operation performed by the processing of a computer according to a program. The mailing list destination database 3 and member information database 5 are realized by memory or a hard disk drive.

The destination address acquisition section 21 acquires a destination list of the mailing list from the mailing list destination database 3.

The specific address judgment section 22 sets the presence or absence of file attachments for each of the destinations included in the mailing list based on the flag information included in the e-mail header.

The e-mail distribution section 23 distributes the e-mail to each of the destinations based on the judgment results of the specific address judgment section 22.

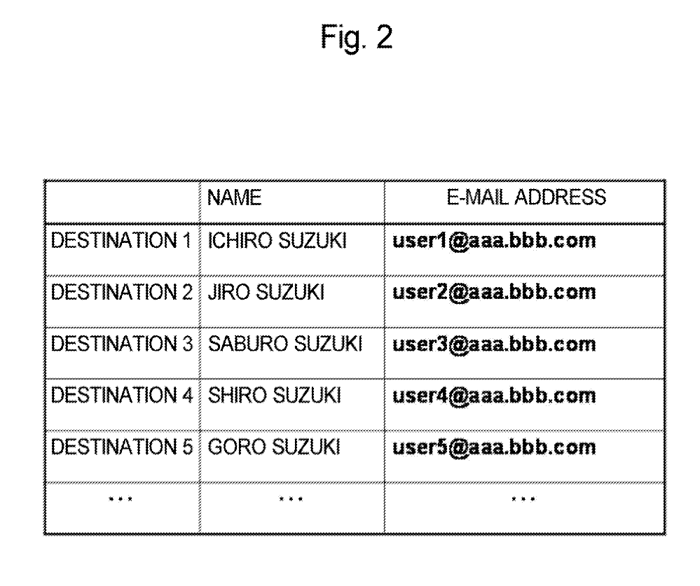

FIG. 2 shows an example of information stored in the mailing list destination database 3. As shown in the figure, a destination name and e-mail address are set for each destination, and there is in essence no difference from information held in the destination databases of mailing list devices of the prior art.

Next, operation of the server 2 is explained. Here, an example is explained in which e-mail is sent from the client terminal 1 addressed to the mailing list.

First, e-mail addressed to the mailing list is transmitted from the client terminal 1 to the server 2 as a result of an operation by the user to transmit e-mail.

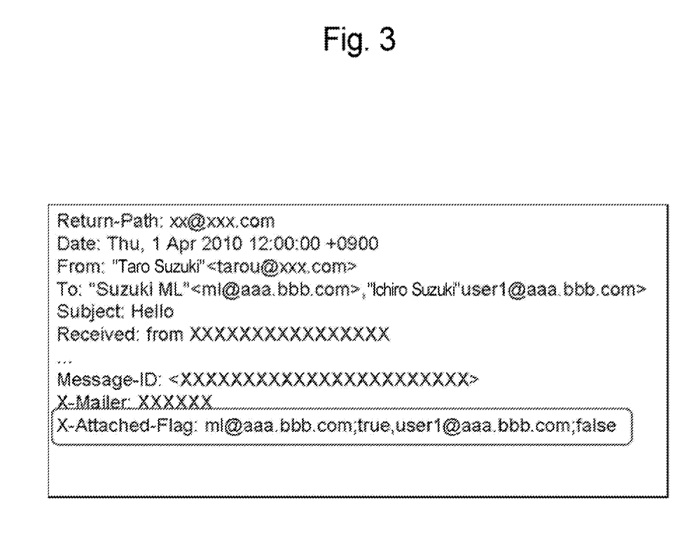

FIG. 3 shows an example of the information of the header section of e-mail transmitted from the client terminal 1. As shown in the figure, a flag information area “X-Attached-Flag:” is provided in the header; here, “true” is set for the mailing list address “ml@aaa.bbb.com”, and “false” is set for the specific address “user1@aaa.bbb.com” selected from among the members included in the mailing list. These flags and specific addresses can be set by the user by an operation using the client terminal 1.

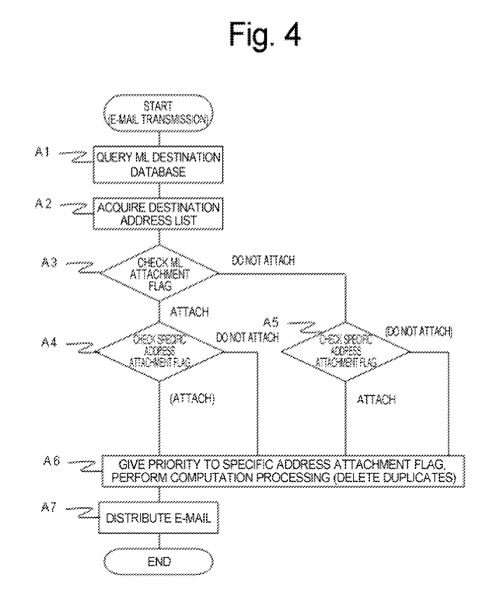

FIG. 4 is a flowchart of operation of the server 2 after receiving the e-mail from the client terminal 1.

First, after the server 2 receives the e-mail from the client terminal 1, the destination address acquisition section 21 issues a query to the mailing list destination database 3 (step A1), and acquires the e-mail addresses of members included in the mailing list designated by the received e-mail (step A2).

Next, in the specific address judgment section 22, the flag information area of the e-mail header is referenced, and based on the flags set for the addresses in the mailing list, a judgment is made as to whether to attach a file to the e-mail itself addressed to the mailing list (step A3).

Next, based on the flag set for a specific address (“user1@aaa.bbb.com”), a judgment is made as to whether to attach the file to the e-mail addressed to the specific addresses (steps A4 and A5).

Next, based on the judgment results of steps A3, A4 and A5, computation processing is performed to decide addresses to which the attached file is transmitted (step A6).

Computation processing is explained in detail. When the flag set for an address of the mailing list is “true”, and moreover the flag set for a specific address is “false”, the e-mail with the file attached is transmitted to members of the mailing list other than those with specific addresses. Further, processing is performed so as to transmit one e-mail without an attached file to the members with specific addresses.

On the other hand, when “false” is set for an address of the mailing list, and moreover “true” is set for specific addresses, the e-mail with file attached is transmitted is transmitted only to the specific addresses, and processing is performed so as to transmit one e-mail without an attached file to the other members of the mailing list.

When “true” is set for an address of the mailing list, and moreover “true” is also set for specific addresses, or when “false” is set for addresses of the mailing list, and moreover “false” is also set for specific addresses, processing is performed to transmit one e-mail with the attached file, and without the attached file, respectively, to the specific addresses.

Finally, based on the results of computation processing in step A6, the e-mail distribution section 23 performs transmission of e-mail to each of the member addresses (step A7). As a result, one e-mail is transmitted to the client terminals 41 to 4n corresponding to each of the member addresses.

Next, a method is explained in which a user transmitting e-mail designates specific addresses and attachment flags by another method.

In the above example, when a user transmits e-mail from the client terminal 1, the specific addresses are directly designated, and flags are set for mailing list addresses and designated specific addresses.

In the other method, however, the user designates specific addresses by designating specific member positions as a condition.

For example, the user designates “department head” as the “position” together with the mailing list address, and also designates a range such as “or higher”, “or lower”, or “exactly”. Further, a flag is designated to set the mailing list address and specific address. In this case, in the flag information area of the header of the e-mail transmitted from the client terminal 1 to the server 2, together with flag information for the mailing list address, the designated position and range information and the flag information are set.

When the server 2 receives the e-mail from the client terminal 1, the destination address acquisition section 21 issues a query to the mailing list destination database 3, and acquires the e-mail addresses of members included in the mailing list.

Next, the specific address judgment section 22 issues a query to the member information database 5, references the position of each member included in the mailing list, judges whether positions correspond to the condition of the range of positions designated in the e-mail, and takes the corresponding member addresses to be specific addresses. For example, when in an e-mail the position “department head” and the range “or higher” are designated, the addresses of members with the position of department head or higher are taken to be specific addresses. Further, when the range is “exactly”, only the addresses of members whose position is department head are taken to be specific addresses.

Next, the specific address judgment section 22 references the flag information area of the e-mail header, and based on flags set for addresses of the mailing list, first judges whether a file is to be attached to the e-mail itself addressed to the mailing list.

Next, based on the flag set for specific addresses, the specific address judgment section 22 judges whether a file is to be attached to the e-mail addressed to the specific addresses.

Next, the specific address judgment section 22 performs computation processing to decide the addresses to which to transmit the attached file. The method of computation processing is similar to that of step A6 in FIG. 4. Further, based on the computation processing results, the e-mail distribution section 23 transmits e-mail to the address of each member. As a result, one e-mail is transmitted to the client terminals 41 to 4n corresponding to each of the member addresses.

As stated above, according to this exemplary embodiment, flag information used to judge destinations for an attached file is provided in an e-mail header, and whether file attachment is necessary is decided for each destination by the specific address judgment section 22, so that a simple method can be used to provide an attached file only to specific destinations of a mailing list. By this means, only the e-mail text itself is transmitted to members for which transmission of the attached file is not necessary, so that communication line traffic and use of storage space in receiving-side terminals can be reduced.

Further, according to this exemplary embodiment, control is executed such that the specific address judgment section 22 performs processing once to transmit e-mail, with an attached file or without an attached file, to specific addresses and to other addresses, so that there is no need to perform the task of sending separate e-mail to recipients for whom the attached file is not necessary, but to whom only the e-mail contents should be sent.

Further, the specific address judgment section 22 references the member information database 5 and judges specific addresses, so that the user can transmit e-mail with an attached file only to the required recipients merely by designating the range of positions of recipients for which the file is to be attached.

In addition to designating a range of positions, an organization name and range (“subordinate” to “XX department” and similar) may be designated. Further, in this exemplary embodiment specific addresses are designated using the conditions of positions and organizations linked to the member information database 5, but the conditions for designation of specific addresses are not limited thereto. For example, the condition of living in a specific area (prefecture, city, town, village, and similar), linked to a postal address database, may be used; and by linking to various other databases, this invention can be applied to any other condition enabling classification of members.

Further, in this exemplary embodiment a flag is used to control the presence or absence of an attached file; but in addition to control of the presence of an attached file, this invention can be used for control where a digital signature is to be appended only for specific addresses, for control when only e-mail addressed to specific addresses is to be encrypted, and similar.

An exemplary advantage according to the invention, a simple method is used to designate specific destinations and destinations other than these from among destinations registered on a mailing list, and a specific action can be performed only for e-mail to be transmitted to the specific destinations.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

A section of or all of the above exemplary embodiments can also be described as in the following addenda, but other configurations are possible.

(Addition 1)

A mailing list device, comprising:

a destination address acquisition section which receives an original e-mail addressed to a mailing list transmitted from a user terminal, and acquires addresses of members included in the mailing list;

a specific address judgment section which, based on information included in a header of the original e-mail, judges whether a specific action is required for each of members included in the mailing list; and

an e-mail distribution section which, based on the judgment result of the specific address judgment section, distributes e-mails, for which control is executed to perform or not to perform the action, to each of the members, wherein

the header of the original e-mail includes a condition for classifying members and flag information designating whether the specific action is needed for members to which the condition applies, and

the specific address judgment section judges whether the specific action is necessary based on the flag information.

(Addition 2)

The mailing list device according to Addendum 1, wherein the specific action is attachment of a file to the e-mail.

(Addition 3)

A program, which causes a computer to function as:

a destination address acquisition section which receives an original e-mail addressed to a mailing list transmitted from a user terminal, and acquires addresses of members included in the mailing list;

a specific address judgment section which, based on information included in a header of the original e-mail, judges whether a specific action is required for each of the members included in the mailing list; and

an e-mail distribution section which, based on the judgment result of the specific address judgment section, distributes e-mails, for which control is executed to perform or not to perform the action, to each of the members, wherein

the header of the original e-mail includes a condition for classifying members and flag information designating whether the specific action is needed for members to which the condition applies, and

the specific address judgment section judges whether the specific action is necessary based on the flag information.

I (We) claim:

1. A mailing list device, comprising:
a destination address acquisition section which receives an original e-mail addressed to a mailing list transmitted from a user terminal, and acquires addresses of members included in the mailing list;
a specific address judgment section which, based on information included in a header of the original e-mail, judges whether a specific action is required for each of members included in the mailing list; and
an e-mail distribution section which, based on the judgment result of the specific address judgment section, distributes e-mails, for which control is executed to perform or not to perform the action, to each of the members, wherein
the header of the original e-mail includes a condition for classifying members and flag information designating whether the specific action is needed for members to which the condition applies, and
the specific address judgment section judges whether the specific action is necessary based on the flag information.

2. The mailing list device according to claim 1, wherein the specific action is attachment of a file to the e-mail.

3. A program, which causes a computer to function as:
a destination address acquisition section which receives an original e-mail addressed to a mailing list transmitted from a user terminal, and acquires addresses of members included in the mailing list;
a specific address judgment section which, based on information included in a header of the original e-mail, judges whether a specific action is required for each of members included in the mailing list; and
an e-mail distribution section which, based on the judgment result of the specific address judgment section, distributes e-mails, for which control is executed to perform or not to perform the action, to each of the members, wherein
the header of the original e-mail includes a condition for classifying members and flag information designating whether the specific action is needed for members to which the condition applies, and
the specific address judgment section judges whether the specific action is necessary based on the flag information.
